(19) United States
(12) Patent Application Publication
(10) Pub. No.: US 2012/0070187 A1
(43) Pub. Date: Mar. 22, 2012

(54) CARTRIDGE AND IMAGE FORMING APPARATUS

(75) Inventors: Toshiaki Takeuchi, Susono-shi (JP); Takeshi Kubota, Mishima-shi (JP); Junichi Matsumura, Numazu-shi (JP); Nobuyoshi Hara, Mishima-shi (JP)

(73) Assignee: CANON KABUSHIKI KAISHA, Tokyo (JP)

(21) Appl. No.: 13/232,205

(22) Filed: Sep. 14, 2011

(30) Foreign Application Priority Data
Sep. 21, 2010 (JP) 2010-210497
Sep. 1, 2011 (JP) 2011-190350

(51) Int. Cl. G03G 21/18; B23P 11/00

(52) U.S. Cl. 399/111; 29/426.1; 29/428

(57) ABSTRACT

A cartridge detachably mountable to a main assembly of an image forming apparatus includes a process member including a shaft acting on an image bearing member; a bearing member for supporting the process member; and a frame including a supporting portion for movably supporting the bearing member. The bearing member is movable, by moving the supporting portion, between a first position in which the process member acts on the image bearing member and a second position which is remote from the image bearing member more than the first position. The cartridge further includes an urging member for urging the bearing member from the second position toward the first position; a suppressing portion for suppressing dismounting of the bearing member, urged by the urging member, from the supporting portion; and a dismounting portion for permitting dismounting of the bearing member from the frame at the second position.

### FIELD OF THE INVENTION AND RELATED ART

The present invention relates to a cartridge detachably mountable to a main assembly of an image forming apparatus and the image forming apparatus including the cartridge.

As a type of the image forming apparatus, there is an electrophotographic image forming apparatus using an electrophotographic image forming process. In the electrophotographic image forming apparatus, a process cartridge type is employed in some cases. In the process cartridge type, an electrophotographic photosensitive member and a process means acting on the photosensitive member are integrally assembled into a cartridge which is detachably mountable to the image forming apparatus main assembly. According to this process cartridge type, maintenance of the image forming apparatus can be performed by a user himself (herself) without relying on a service person and therefore operativity can be improved remarkably. For that reason, this process cartridge type has been widely used with respect to the image forming apparatus.

Such a process cartridge forms an image on a recording material (medium) by using a developer. With the formation of the image, the developer is correspondingly consumed. Then, when the developer is consumed to the extent that the image of a satisfactory quality to the user of the process cartridge cannot be formed, the process cartridge loses its commercial value.

Therefore, the process cartridge has been conventionally remanufactured (e.g., Japanese Patent No. 3363889). Parts used for the process cartridge are disassembled or exchanged, so that the process cartridge is commercialized again. For that reason, the parts used for the process cartridge have been required to have disassembling easiness.

In the conventional contact, a bearing member rotatably supporting the process means is supported by a frame in a retained state (e.g., Japanese Laid-Open Patent Application No. Hei 6-301249). For that reason, when the bearing member is dismounted from the frame, there is a need to elastically deform the frame to dismount the bearing member from the frame.

However, in the conventional constitution, when the bearing member of the member was dismounted from a drum supporting frame, a supporting portion is elastically deformed and then the bearing member was pulled out in a photosensitive drum direction while keeping the supporting portion in an expanded state. When the dismounting is performed in such a manner, there is a possibility that the supporting portion is excessively expanded to be whitened or deformed.

### SUMMARY OF THE INVENTION

A principal object of the present invention is to provide a cartridge capable of supporting a bearing member of a process means by a frame with high accuracy and capable of easily performing dismounting of the bearing member from the frame.

According to an aspect of the present invention, there is provided cartridge detachably mountable to a main assembly of an image forming apparatus, comprising:

a process member including a shaft acting on an image bearing member;

a bearing member for supporting the process member;

a frame including a supporting portion for movably supporting the bearing member;

wherein the bearing member is movable, by moving the supporting portion, between a first position in which the process member acts on the image bearing member and a second position which is remote from the image bearing member more than the first position,

an urging member for urging the bearing member from the second position toward the first position;

a suppressing portion for suppressing dismounting of the bearing member, urged by the urging member, from the supporting portion; and

a dismounting portion for permitting dismounting of the bearing member from the frame at the second position.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a perspective view of a supporting structure for a bearing member in First Embodiment.

FIG. 2 is a schematic sectional view of an electrophotographic image forming apparatus in First Embodiment.

FIG. 3 is a schematic sectional view of a process cartridge in First Embodiment.

FIG. 4 is a perspective view for illustrating assembling and disassembling of a drum unit in First Embodiment.

Part (a) of FIG. 5 is a side view of the supporting structure for the bearing member in First Embodiment, and (b) and (c) of FIG. 5 are sectional views of the supporting structure for the bearing member in First Embodiment.

FIG. 6 is a perspective view for illustrating the assembling of a developing unit to the drum unit in First Embodiment.

Part (a) of FIG. 7 is a side view of a supporting structure for a bearing member in Second Embodiment, and (b) and (c) of FIG. 7 are sectional views of the supporting structure for the bearing member in Second Embodiment.

FIG. 8 is a perspective view of the bearing member in Second Embodiment.

FIG. 9 is an illustration of a supporting structure for a bearing member in Third Embodiment.

Part (a) of FIG. 10 is a side view of the supporting structure for the bearing member in Third Embodiment, and (b) and (c) of FIG. 10 are sectional views of the supporting structure for the bearing member in Third Embodiment.

FIG. 11 is a perspective view of the supporting structure for the bearing member in Third Embodiment.

FIG. 12 is a perspective view of a supporting structure for a bearing member in a modified example of Third Embodiment.

Part (a) of FIG. 13 is a sectional view of the supporting structure for the bearing member in the modified example of Third Embodiment, and (b) and (c) of FIG. 13 are sectional views of the supporting structure for the bearing member in the modified example of Third Embodiment.

FIG. 14 is a schematic sectional view of a process cartridge in Fourth Embodiment.

Part (a) and (b) of FIG. 15 are perspective views of a supporting structure for a bearing member in Fifth Embodiment.

### DESCRIPTION OF THE PREFERRED EMBODIMENTS

Embodiments of the present invention will be described with reference to the drawings. However, dimensions, shapes, relative arrangements of constituent elements (parts) and the like described in the following embodiments do not limit the scope of the present invention thereto unless otherwise specified. Further, materials, shapes and the like once described in the following embodiments are similar to those first described unless otherwise particularly specified again.

In the following description, an electrophotographic image forming apparatus forms an image on a recording material by using an electrophotographic image forming method. The electrophotographic image forming apparatus include, e.g., an electrophotographic copying machine, an electrophotographic printer (such as a laser beam printer or an LED printer), a facsimile machine, a word processor and the like.

Further, a process cartridge is prepared by integrally assembling an electrophotographic photosensitive member, which is an image bearing member, and a process means acting on the electrophotographic photosensitive member into a cartridge which is detachably mountable to an image forming apparatus main assembly. As the process means, at least one of a charging means, a developing means, a cleaning means and a transfer means is included.

Further, a longitudinal direction of the process cartridge refers to a direction crossing a mounting and demounting direction in which the process cartridge is mounted to and dismounted from the main assembly (i.e., refers to a direction substantially perpendicular to the mounting and dismounting direction or refers to an axial direction of the image bearing member).

### First Embodiment

(General structure of Electrophotographic Image Forming Apparatus)

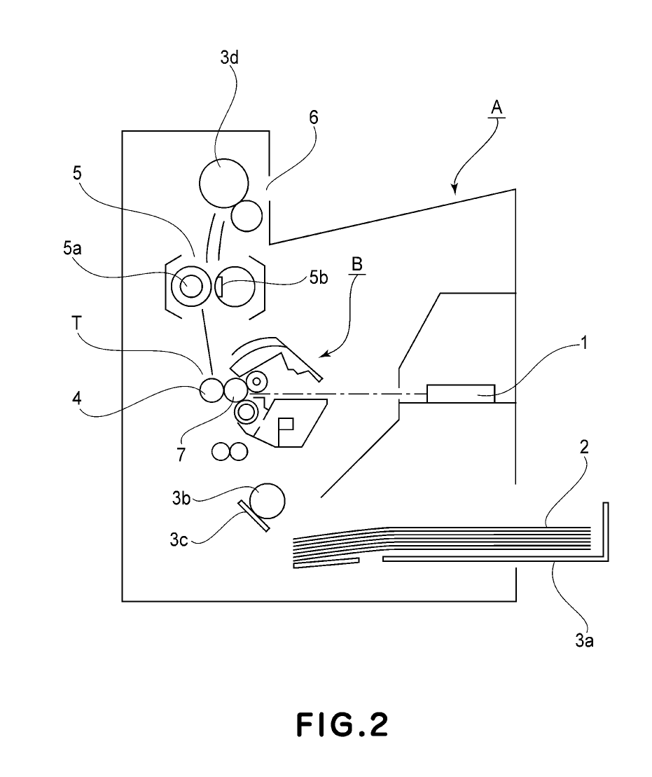

First, a general structure of the electrophotographic image forming apparatus will be described with reference to FIG. 2. FIG. 2 is a schematic sectional view of the electrophotographic image forming apparatus in this embodiment. More specifically, FIG. 2 is a schematic sectional view of a laser beam printer as an example of the image forming apparatus.

As shown in FIG. 2, in the image forming apparatus (laser beam printer) A in this embodiment, information light on the basis of image information is emitted from an optical system 1 as an optical means to a drum-like electrophotographic photosensitive member (image bearing member), hereinafter referred to as a photosensitive drum) 7. Thus, an electrostatic latent image is formed on the photosensitive drum 7. This electrostatic latent image is developed with a developer (hereinafter referred to as a toner), so that a toner image is formed.

On the other hand, in synchronism with the formation of the toner image, a recording material (e.g., recording paper, OHP sheet, cloth or the like) 2 is separated and fed one by one from a cassette 3a by a pick-up roller 3b and a press-contact member 3c which press-contacts the pick-up roller 3b.

The fed recording material 2 is conveyed to a transfer portion T where the photosensitive drum 7 of a process cartridge B and a transfer roller 4 as a transfer means oppose each other.

Onto the recording material 2 conveyed to the transfer portion T, the toner image formed on the photosensitive drum 7 is transferred by the transfer roller 4 to which a voltage is applied, and then the recording material 2 is conveyed to a fixing means 5.

The fixing means 5 includes a driving roller 5a and a heater 5b and applies heat and pressure to the recording material 2 passing through the fixing means 5, thus fixing the transferred toner image on the recording material 2.

A discharging roller 3d is constituted so that it conveys the recording material 2 on which the toner image is fixed and discharges the recording material 2 from a discharging portion 6 via a reverse conveying path.

### (Process Cartridge)

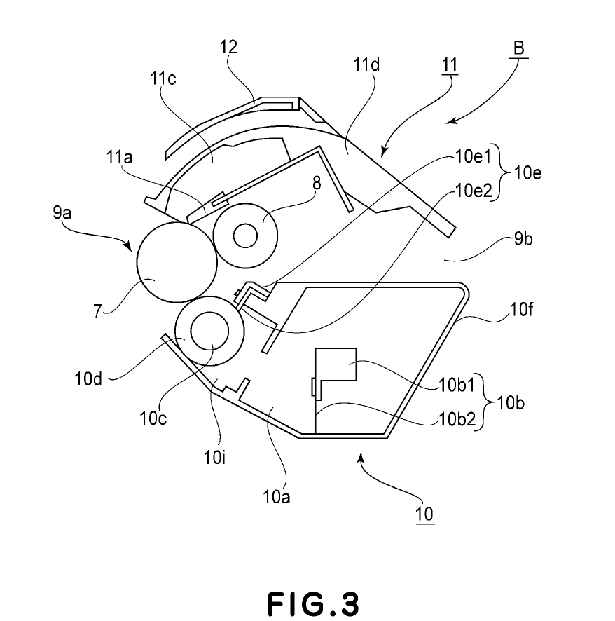

Next, the general structure of the process cartridge B will be schematically described with reference to FIG. 3. FIG. 3 is a schematic sectional view of the process cartridge B in this embodiment.

As shown in FIG. 3, the process cartridge B includes a drum unit 11 in which the photosensitive drum 7 and at least one process means are provided. Here, as the process means, there are, e.g., a charging means for electrostatically charging the photosensitive drum 7, a developing means for developing the electrostatic latent image formed on the photosensitive drum 7, a cleaning means for removing the toner remaining on the photosensitive drum 7, and the like.

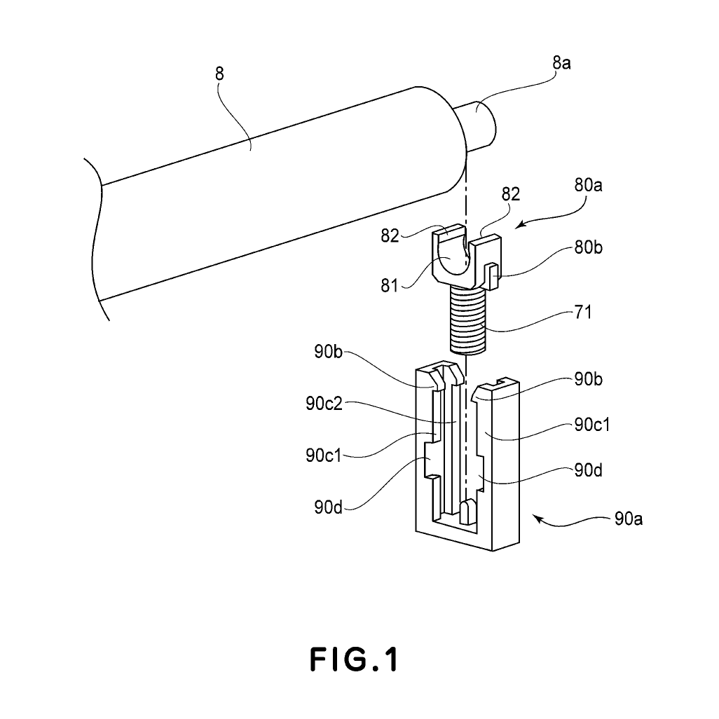

The process cartridge B in this embodiment includes the photosensitive drum 7 provided with a photosensitive layer. To the photosensitive drum 7, a voltage is applied from a charging roller 8 which is the charging means (charging member), by which the surface of the photosensitive drum 7 is uniformly charged. The charged surface of the photosensitive drum 7 is exposed, through an exposure opening 9b, to information light (light image) on the basis of image information from an optical system 1 (FIG. 1). As a result, the electrostatic latent image is formed on the surface of the photosensitive drum 7. Thereafter, the electrostatic latent image is to be developed by a developing unit 10.

The developing unit 10 feeds the toner, contained in a toner chamber 10a which is a toner accommodating portion, by a rotatable toner feeding member 10b. Then, a developer carrying member 10d containing a fixed magnet 10c is rotated. With this, a toner layer to which a triboelectric charge is provided by a developing blade 10e is formed on the developer carrying member 10d and then the toner (layer) is transferred onto the photosensitive drum 7 depending on the electrostatic latent image. By this operation, the toner image is formed into a visualized image.

Then, a voltage of an opposite polarity to that of the toner image is applied to the transfer roller 4, so that the toner image is transferred onto the recording material 2 (FIG. 2). Thereafter, the toner remaining on the photosensitive drum 7 is scraped by a cleaning blade 11a and is collected in a removed toner accommodating portion 11c.

The process cartridge B in this embodiment rotatably supports the photosensitive drum 7. Further, the process cartridge B is constituted by a drum supporting frame 11d into which the cleaning blade 11a and the charging roller 8 are incorporated and by a developing device frame 10f into which the developer carrying member 10d and the toner chamber 10a are incorporated.

### (Drum Unit)

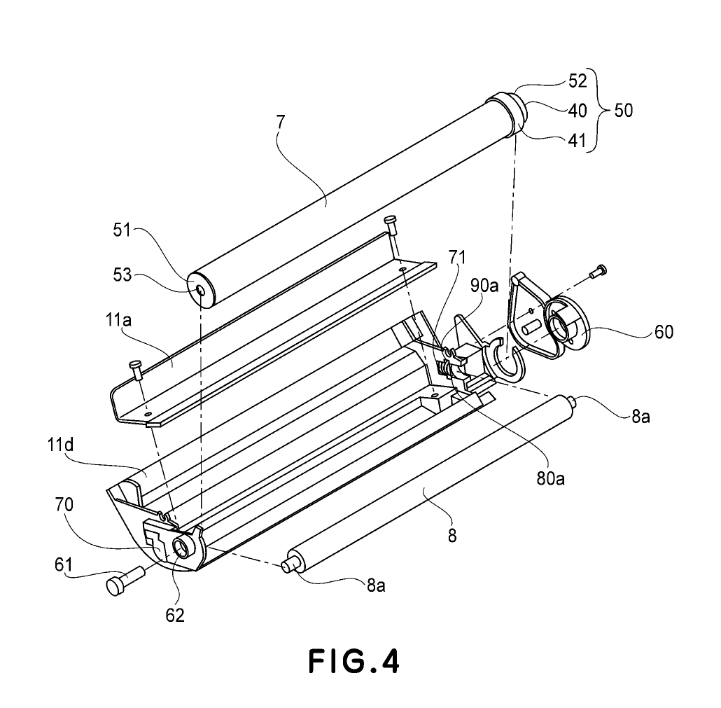

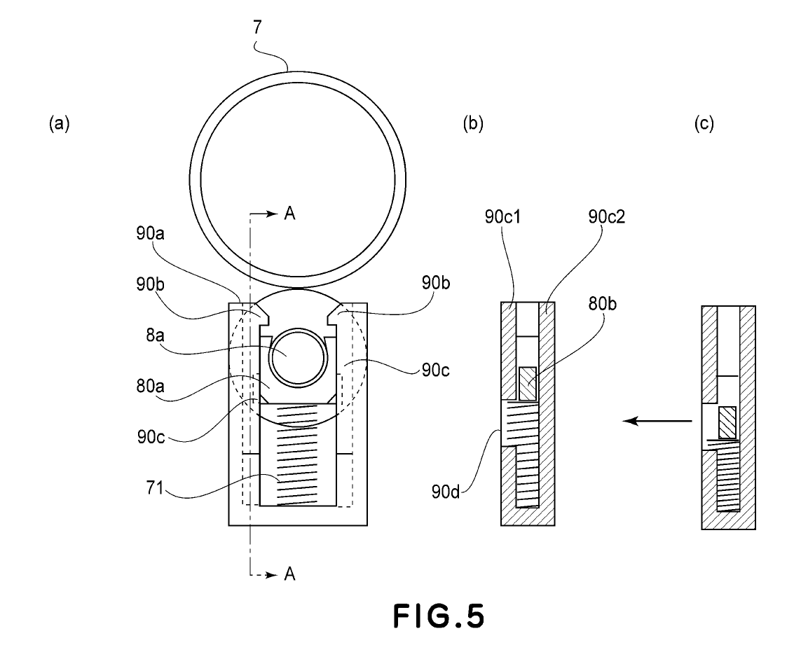

Next, a structure of the drum unit 11 constituting a part of the process cartridge B will be specifically described with reference to FIGS. 3 and 4. FIG. 4 is a perspective view for illustrating assembling and disassembling of the drum unit 11 in this embodiment. However, in FIG. 4, a drum shutter 12 show in FIG. 3 is omitted.

The drum unit 11 is constituted by the photosensitive drum 7, the drum supporting frame 11d, the charging roller 8, the cleaning blade 11a and the drum shutter 12.

To the photosensitive drum 7, a drum gear 50 is connected at an end of the photosensitive drum 7. The drum gear 50 is prepared by integrally assembling a coupling 40 which is a drive transmitting means for transmitting a driving force from the image forming apparatus main assembly to the process cartridge B, a shaft portion 52 for permitting the photosensitive drum 7 to be rotatably supported by the drum supporting frame 11d, and a drive transmitting gear 41 for transmitting the driving force to the developer carrying member 10d. Further, at the other end of the photosensitive drum 7, a flange 51 provided with a supporting hole 53 is connected to the photosensitive drum 7.

At the coupling 40 side of the photosensitive drum 7, a bearing 60 is connected to the drum supporting frame 11d by a fixing means such as a screw. Further, at the other side of the photosensitive drum 7, a metallic positioning pin 61 is press-fitted into a positioning portion 62 of the drum supporting frame 11d. As a result, the photosensitive drum is rotatably supported by the drum supporting frame 11d.

To the flange 51, a metal-made earth plate (not shown) is attached so as to contact an inner diameter portion of a drum cylinder and by contact of the earth plate to the cylinder inner diameter portion of the photosensitive drum 7 and the positioning pin 61, electrical conduction between the photosensitive drum 7 and the positioning pin 61 is ensured.

The charging roller 8 is used for charging the surface of the photosensitive drum 7 and is rotatably provided on the drum supporting frame 11d. This charging roller 8 is prepared by providing successively, on a metal-mode roller shaft 8a, an electroconductive elastic layer, a high-resistance elastic layer and a protective film.

### (Supporting Structure for Charging Roller)

Next, the supporting structure for the charging roller 8 will be specifically described with reference to FIGS. 1 to 5.

FIG. 1 is a perspective view of the supporting structure for a bearing member in this embodiment. Part (a) of FIG. 5 is a side view of the supporting structure for the bearing member in this embodiment, and (b) and (c) of FIG. 5 are sectional views of the supporting structure for the bearing member in this embodiment.

Each of both ends of the roller shaft 8a is rotatably supported by a bearing member 80a. Further, the bearing member 80a is attached to a supporting portion 90a. The supporting portion 90a is provided on the drum supporting frame 11d.

The supporting portion 90a has an arm pair-like shape as described later. The bearing member 80a is forcedly inserted into a space between arm-like portions while elastically deforming the supporting portion 90a. The bearing member 80a is attached to the supporting portion 90a along inner rails of the supporting portion 90a so as to be slidable in a radial direction of the photosensitive drum 7. Further, the supporting portion 90a is provided with projections (preventing portions) 90b at its (upper) ends. By the projections 90b, during drum assembling, the bearing member 80a is prevented from disconnecting from the supporting portion 90a.

Further, to the supporting portion 90a, a compression spring 71 is attached by using the bearing member 80a as an urging member. By this compression spring 71, the charging roller 8 is urged toward the photosensitive drum 7 via the bearing member 80a.

As shown in FIG. 5, the bearing member 80a is supported by the supporting portion 90a and is constituted so as to be slidable and movable between a position (first position) in which the charging roller 8 is contacted to the photosensitive drum 7 and a position (second position) in which the charging roller 8 is separated (spaced) from the photosensitive drum 7. Incidentally, the first position is such a position that the process means (process member) such as the charging roller 8 acts on the photosensitive drum 7. In this embodiment, the charging roller 8 is contacted to the photosensitive drum 7 to charge the photosensitive drum 7 but the present invention is not limited thereto. In such a case where the charging roller 8 charges the photosensitive drum 7 with a minute gap, the position of the bearing member 80a in which the charging roller 8 and the photosensitive drum 7 form the minute gap is the first position. Further, the second position is such a position that the bearing member 80a is moved away from the photosensitive drum 7. Here, (a) of FIG. 5 is the side view at the first position in which the charging roller 8 is contacted to the photosensitive drum 7, (b) of FIG. 5 is the sectional view at the first position, and (c) of FIG. 5 is the sectional view at the second position in which the charging roller 8 is separated from the photosensitive drum 7.

The bearing member 80a is provided with a bearing-side longitudinal direction movement preventing portion 80b having a projected shape extending in the sliding direction described above.

As shown in (b) of FIG. 5, when the bearing-side longitudinal direction movement preventing portion 80b is located at the first position the bearing-side longitudinal direction movement preventing portion 80b is sandwiched by the supporting portion 90a which has the arm pair-like shape constituted so that each its arm-like portions is configured so that its inner and outer longitudinal side portions are provided adjacently to each other so as to sandwich the bearing-side longitudinal direction movement preventing portion 80b with respect to the longitudinal direction. These arm-like portions are provided in a pair with respect to a direction crossing the axial direction of the charging roller 8. Specifically, the bearing longitudinal direction movement preventing portion 80b is sandwiched by a frame-side longitudinal direction movement preventing portion 90c of the supporting portion 90a, i.e., sandwiched between a frame-side inner longitudinal direction movement preventing portion 90c1 and a frame-side outer longitudinal direction movement preventing portion 90c2. For this reason, the longitudinal direction movement of the bearing member 80a is prevented by the contact of the bearing-side longitudinal direction movement preventing portion 80b to the frame-side inner longitudinal direction movement preventing portion 90c1 and the frame-side outer longitudinal direction movement preventing portion 90c2.

Further, as shown in (c) of FIG. 5, when the bearing-side longitudinal direction movement preventing portion 80b is located at the second position, the longitudinal direction movement of the bearing member 80a is, similarly as described above, prevented by the frame-side inner longitudinal direction movement preventing portion 90c1 and the frame-side outer longitudinal direction movement preventing portion 90c2. Further, the frame-side inner longitudinal direction movement preventing portion 90c1 is provided with a cut-away portion (dismount portion) 90d having a size such that the bearing-side longitudinal direction movement preventing portion 80b can pass through the frame-side inner longitudinal direction movement preventing portion 90c1 via the cut-away portion 90d. At this time, the bearing-side longitudinal direction movement preventing portion 80b does not contact the frame-side inner longitudinal direction movement preventing portion 90c1 or the frame-side outer longitudinal direction movement preventing portion 90c2, so that the bearing member 80a can be dismounted from the drum supporting frame 11d.

Here, in this embodiment, the cut-away portion 90d is provided to any one of the frame-side inner longitudinal direction movement preventing portion 90c1 and the frame-side outer longitudinal direction movement preventing portion 90c2. As a result, a direction in which the bearing member 80a is dismounted from the drum supporting frame 11d can be limited to one of two directions with respect to the longitudinal direction.

In this embodiment, the cut-away portion 90d is provided to the frame-side longitudinal direction movement preventing portion preventing portion 90c1 as a longitudinal inner portion, so that the bearing member 80a can be dismounted, at the second position, toward the longitudinal side (an arrow direction in (c) of FIG. 5). Further, the movement of the bearing member 80a toward the longitudinal outside is prevented by the contact between the bearing-side longitudinal direction movement preventing portion 80b and the frame-side longitudinal direction movement preventing portion 90c2 provided at the longitudinal outside.

That is, the bearing member 80a includes, at the first position, the bearing-side longitudinal direction movement preventing portion 80b provided in at least one of the two directions with respect to the axial direction of the charging roller 8. At the first position, the bearing-side longitudinal direction movement preventing portion 80b overlaps with the supporting portion 90a as seen from the axial direction of the charging roller 8. On the other hand, at the second position, the bearing-side longitudinal direction movement preventing portion 80b does not overlap with the supporting portion 90a as seen from the axial direction of the charging roller 8, thus being dismountable.

Incidentally, in this embodiment, the assembling of the bearing member 80a to the supporting portion 90a is performed from the photosensitive drum 7 side. However, the assembling direction is not limited thereto but may also be the longitudinal direction. Specifically, the bearing member 80a can be assembled to the supporting portion 90a in the longitudinal direction (a position opposite to the arrow direction in (c) of FIG. 5) so that the bearing-side longitudinal direction movement preventing portion 80b enter the supporting portion 90a through the cut-away portion 90d provided to the frame-side inner longitudinal direction movement preventing portion 90c1. In this case, the cut-away portion 90d constitutes an assembling portion. During the assembling, an assembling position with respect to the longitudinal direction is the second position. Thereafter, the bearing member 80a is moved toward the frame by urging force of the compression spring 71 and is stopped at an abutting position in which the bearing member 80a abuts against the projection 90b provided at the end of the supporting portion 90a.

Here, the bearing member 80a includes, as shown in FIG. 1, a U-shaped engaging portion 81, so that the roller shaft 8a is constituted so as not to be disengaged from the surface member 80a. Specifically, an entering opening 82 provided at an end of the engaging portion 81 is constituted so as to have a diameter narrower (smaller) than that of the roller shaft 8a. In this constitution, when the roller shaft 8a is assembled, the roller shaft 8a is forcedly engaged into the engaging portion 81 through the entering opening 82. When the entering opening 82 is elastically deformed and expanded and the roller shaft 8a is completely engaged in the engaging portion 81, the expanded entering opening 82 is elastically restored to the original state. Thus, the roller shaft 8a is engaged in the engaging portion 81 of the bearing member 80a.

During image formation, the charging roller 8 is rotated by the rotation of the photosensitive drum 7 and at this time, a voltage is applied to the charging roller 8 to uniformly charge the surface of the photosensitive drum 7. For that purpose, one of the bearing members 80a provided at longitudinal ends of the charging roller 8 is constituted by an electroconductive member of an electroconductive polyacetal resin material or the like. Thus, from the image forming apparatus A, the voltage is applied to the roller shaft 8a via a contact member 60 (FIG. 4) and the compression spring 71, which is electroconductive, for urging the bearing member 80a. Further, the bearing member 80a provided at the other end side is also constituted with a polyacetal resin material which has a good sliding property with the metal-mode roller shaft 8a and which is excellent in anti-wearing property.

### (Process Cartridge Recycling)

Recycling of the process cartridge in First Embodiment will be described.

When the developer is consumed to the extent that the process cartridge cannot form an image of a satisfactory quality for the user, the process cartridge B loses its commercial value. Therefore, for the purposes of resource saving, energy saving and reduction of waste generation, recycling (reproduction, reuse) of the parts has been made conventionally.

During the recycling, the charging roller 8 and the developer carrying member and the like are reassembled through the steps of screening, cleaning, inspection and the like and then are used but the drum supporting frame 11d and the like are crushed and then are reused as a material. At this time, in the case where the drum supporting frame 11d and the bearing member 80a are constituted by different materials, when those members are crushed together, a mechanical property is deteriorated during the reuse as the material. For this reason, the drum supporting frame 11d are the bearing member 80a may desirably be originally formed of the same material.

However, in order to obtain a necessary function, the bearing member 80a is formed of the polyacetal resin material as described above and the drum supporting frame 11d is formed of a polystyrene resin material, thus being constituted by different materials. For this reason, there is a need to remove and fractionate the bearing member 80a, so that a constitution by which the bearing member 80a is easily dismountable from the drum supporting frame 11d is required.

In this embodiment, by using the constitution as described above, there is no need to elastically deform the supporting portion 90a during the disassembling. For this reason, the bearing member 80a can be easily dismounted from the supporting portion 90a.

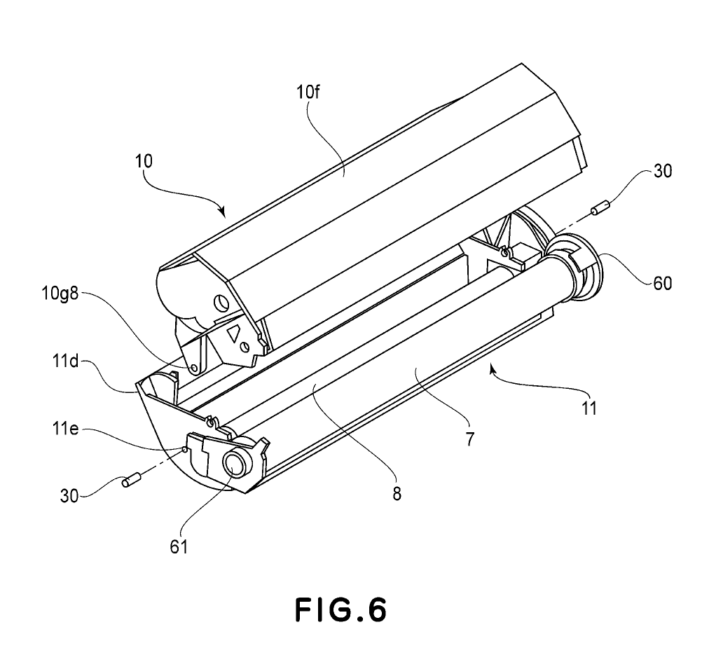

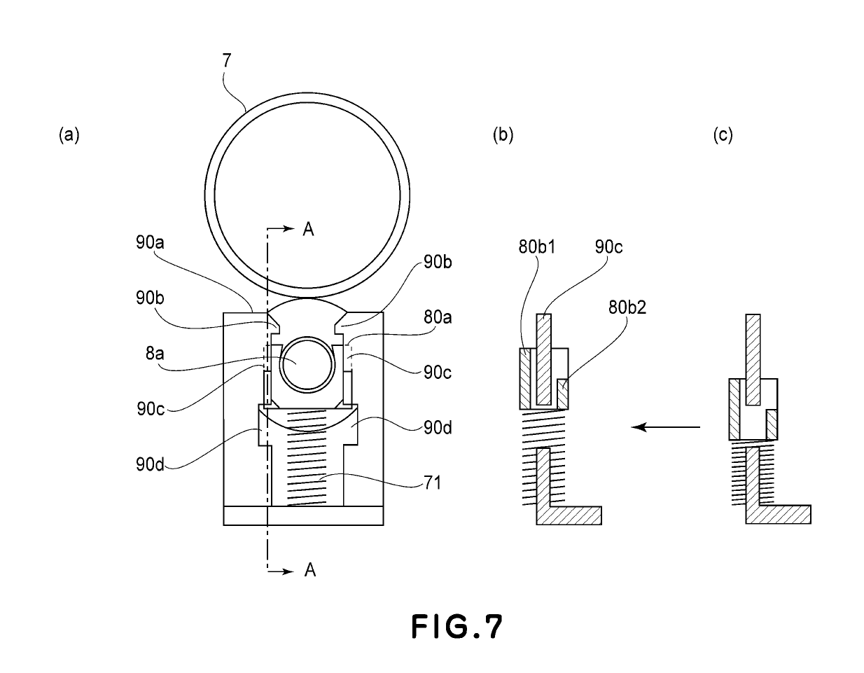

A disassembling method of a spent process cartridge B will be specifically described with reference to FIGS. 4 to 6. FIG. 6 is a perspective view for illustrating assembling of a developing unit to the drum unit in this embodiment.

First, a pin 30 engaged in a hole 11e and a connecting hole 10g 8 is pulled out in the longitudinal direction to separate the developing unit 10 and the drum unit 11. A screw fixed to a bearing 60 of the drum unit 11 is disconnected and then the bearing 60 and a positioning pin 61 are disconnected, so that the photosensitive drum 7 is dismounted from the drum supporting frame 11d. Thereafter, the charging roller 8 is pulled out in the photosensitive drum 7 axial direction, so that the charging roller 8 is dismounted from the bearing member 80a. The diameter of the roller shaft 8a of the charging roller 8 is smaller than the gap of the pair of projections 90b and therefore the charging roller 8 can be pulled out in the photosensitive drum 7 axial direction. The cleaning blade 11a becomes dismountable by disconnecting the screws fixed at both ends. Then, the residual toner in the removed toner accommodating portion 11c is removed.

Also with respect to the developing unit 10, after the respective parts are disassembled, when the residual toner in the toner chamber 10a and a developer chamber 10i (FIG. 3) is removed, a disassembling operation is completed.

In this state, as described above, the bearing member 80a is pushed from the photosensitive drum 7 side. Then, the bearing member 80a is slid to the second position and thereafter is shifted in the longitudinal direction. Thus, the bearing member 80a can easily be dismounted from the drum supporting frame 11d.

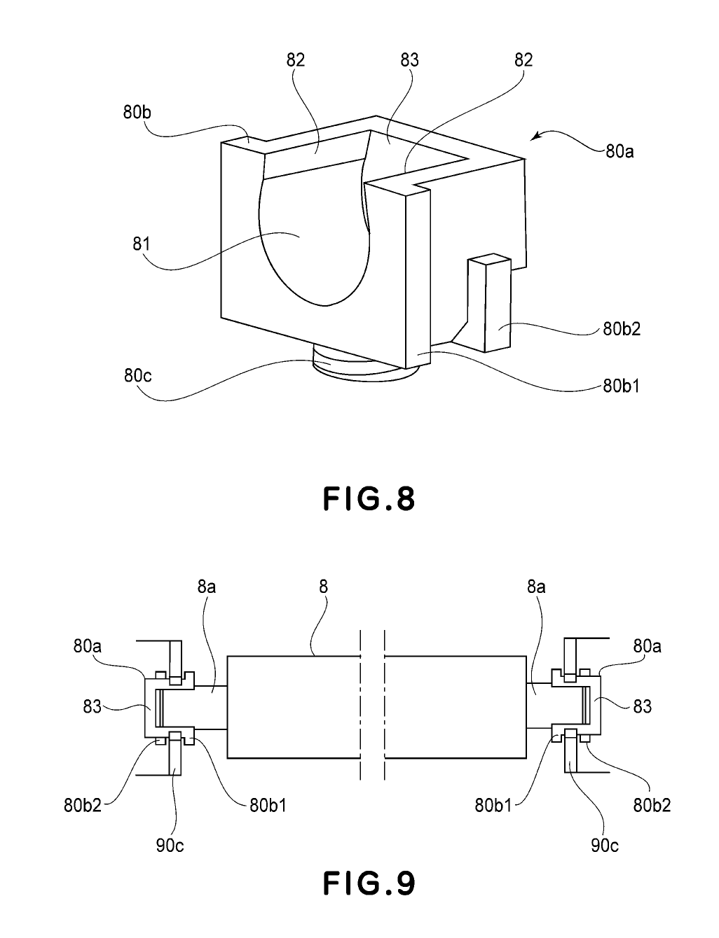

Here, by integrally fixing the bearing member 80a and the compression spring 71, the bearing member 80a and the compression spring 71 can be dismounted simultaneously from the drum supporting frame 11d. As a means for integrally fixing the bearing member 80a and the compression spring 71, there is an insert molding of the compression spring 71. Further, e.g., as shown in FIG. 8, a circular projected-shaped press-fitting portion 80c is provided on the bearing member 80a and an inner diameter of the compression spring 71 is set to be smaller than an outer diameter of the press-fitting portion 80c, and then the press-fitting portion 80c may be inserted and fixed in the compression spring 71.

### Second Embodiment

The bearing member supporting structure of the drum supporting frame in this embodiment will be described with reference to FIGS. 7 and 8. Constituent elements similar to those in First Embodiment are represented by the same reference numerals or symbols. Parts (a), (b) and (c) of FIG. 7 are a side view and sectional views of the supporting structure for the bearing member in this embodiment. Here, (a) of FIG. 7 is the side view of the supporting structure at the first position in which the charging roller 8 is contacted to the photosensitive drum 7, (b) of FIG. 7 is the sectional view of the supporting structure at the first position, and (c) of FIG. 7 is the sectional view of the supporting structure at the second position in which the charging roller 8 is separated from the photosensitive drum 7. FIG. 8 is a perspective view of the bearing member in this embodiment.

Here, the supporting portion 90a is provided with a frame-side longitudinal direction movement preventing portion 90c having an arm pair-like shape constituted to sandwich the bearing member 80a. Further, the bearing member 80a is provided, as the preventing portion, with a bearing-side inner longitudinal direction movement preventing portion 80b1 and a bearing-side outer longitudinal direction movement preventing portion 80b2 which are extended in the sliding direction. Further, at the first position, to both sides of the frame-side longitudinal direction movement preventing portion 90c, the bearing-side inner and outer longitudinal direction movement preventing portions 80b1 and 80b2 are adjacent. For this reason, at the first position, the movement of the bearing member 80a in the longitudinal direction is prevented by the contact of the frame-side longitudinal direction movement preventing portion 90c to the bearing-side inner and outer longitudinal direction movement preventing portions 80b1 and 80b2.

Further, the frame-side longitudinal direction movement preventing portion 90c is provided with a cut-away portion 90d. As a result, at the second position, at least one of the bearing-side inner and outer longitudinal direction movement preventing portions 80b1 and 80b2 does not contact the frame-side longitudinal direction movement preventing portion 90c. For this reason, the bearing member 80a can be dismounted from the drum supporting frame 11d in the longitudinal direction (arrow direction).

At that time, as shown in (b) and (c) of FIG. 7, a preventing width in the sliding direction is set so that only one of the bearing-side inner and outer longitudinal direction movement preventing portions 80b1 and 80b2 is longer than the other. As a result, the direction in which the bearing member 80a is dismounted from the drum supporting frame 11d can be limited to one direction.

In this embodiment, the width, with respect to the sliding direction, of the bearing-side inner longitudinal direction movement preventing portion 80b1 at the longitudinal inside is set at a larger value. As a result, at the second position, the bearing member 80a can be dismounted only toward the longitudinal inside (the arrow direction in (c) of FIG. 7). At that time, the movement of the bearing member 80a toward the longitudinal outside (an opposite direction from the arrow direction) is prevented by the contact between the frame-side longitudinal direction movement preventing portion 90c and the bearing-side inner longitudinal direction movement preventing portion 80b1.

Further, as shown in FIG. 8, the bearing member 80a may also be provided with an abutting portion (contact portion) 83 for preventing the movement of the charging roller 8 in the longitudinal direction.

In this embodiment, compared with First Embodiment, rigidity of the supporting portion 90a can be set at a low level. For this reason, the insertion of the bearing member 80a while elastically deforming the supporting portion 90a becomes easy.

### Third Embodiment

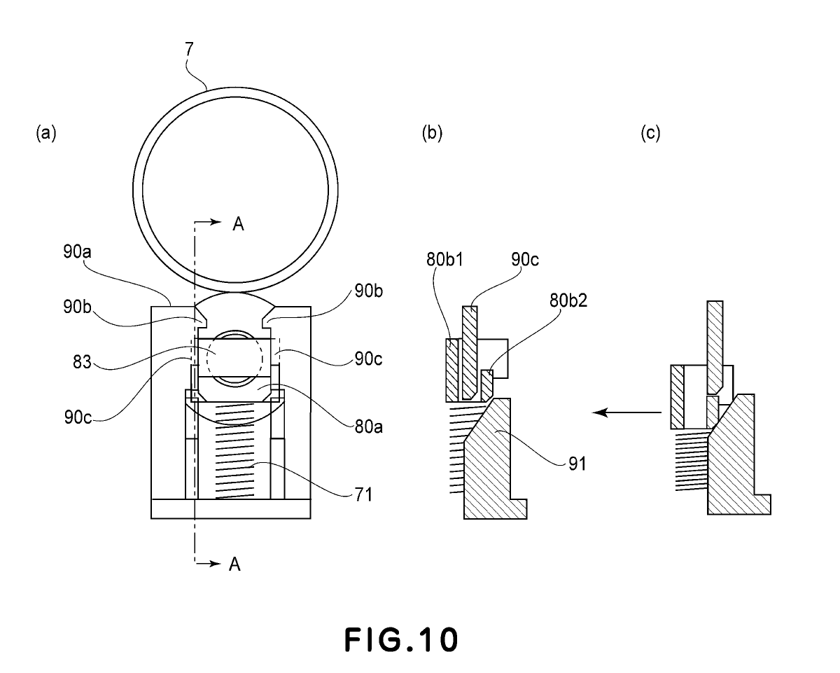

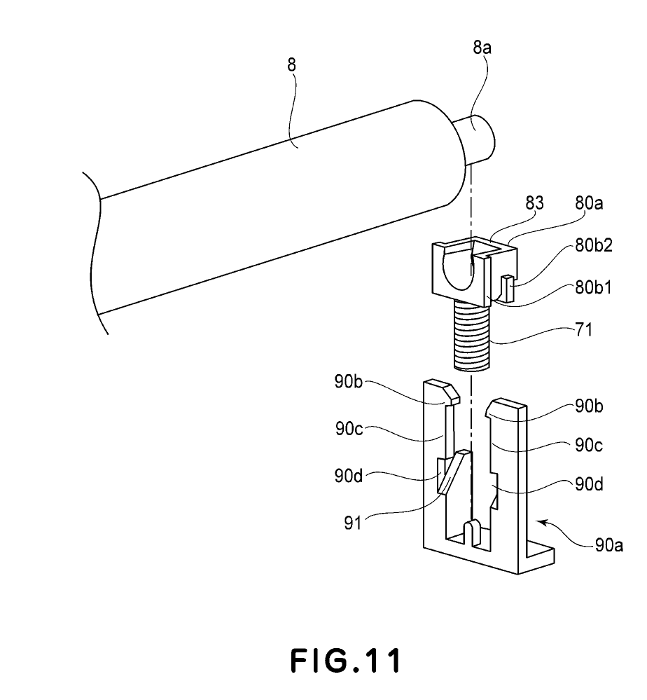

The bearing member supporting structure of the drum supporting frame in this embodiment will be described with reference to FIGS. 9, 10 and 11. Constituent elements similar to those in First Embodiment are represented by the same reference numerals or symbols. FIG. 9 is a schematic view for illustrating the supporting structure for the bearing member in this embodiment. Parts (a), (b) and (c) of FIG. 10 are a side view and sectional views of the supporting structure for the bearing member in this embodiment. Here, (a) of FIG. 10 is the side view of the supporting structure at the first position in which the charging roller 8 is contacted to the photosensitive drum 7, (b) of FIG. 10 is the sectional view of the supporting structure at the first position, and (c) of FIG. 10 is the sectional view of the supporting structure at the second position in which the charging roller 8 is separated from the photosensitive drum 7. FIG. 11 is a perspective view of the supporting structure for the bearing member in this embodiment.

As shown in FIGS. 10 and 11, the supporting portion 90a is provided with a guiding portion 91 which is inclined at an angle with respect to the sliding portion. When the bearing member 80a is moved from the first position to the second position, the bearing member 80a is guided in the longitudinal inside direction while being contacted to the guiding portion 91. The longitudinal inside direction is the axial direction of the charging roller 8 and a direction toward a central portion of the charging roller 8.

Further, the preventing widths, with respect to the sliding direction, of the bearing-side inner and outer longitudinal direction movement preventing portions 80b1 and 80b2 are set so that only the bearing-side inner longitudinal direction movement preventing portion 80b1 is long as shown in (b) of FIG. 10. As a result, the direction in which the bearing member 80a is dismounted from the drum supporting frame 11d can be limited to the longitudinal inside direction.

Further, as shown in FIG. 9, at both ends of the charging roller 8, abutting portions (contact portions) 83 of the bearing member 80a are provided.

As a result, in a state in which the charging roller 8 is assembled to the bearing member 80a, the movement of the charging roller 8 in the longitudinal inside direction relative to the bearing member 80a is prevented by contact between the charging roller 8 and the abutting portions 83, so that the bearing member 80a cannot be moved to the second position. For that reason, there is no dismounting of the bearing member 80a from the drum supporting frame 11d. Further, in a state in which the charging roller 8 is dismounted from the bearing member 80a, the bearing member 80a can be easily dismounted from the drum supporting frame 11d by being pushed from the photosensitive drum 7 side.

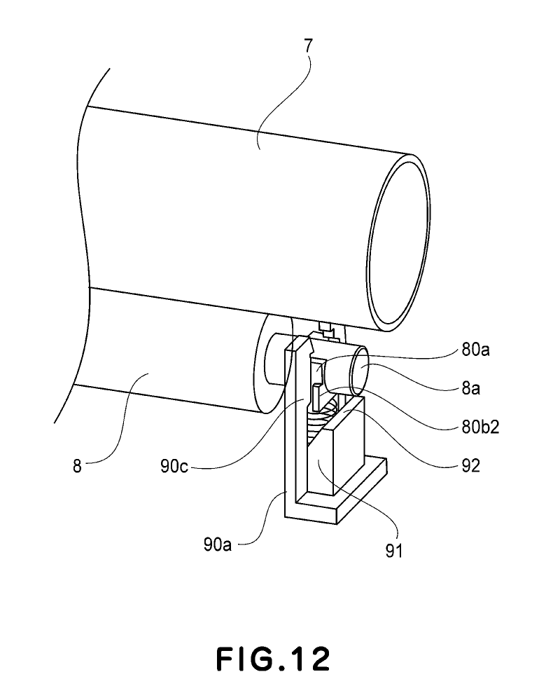

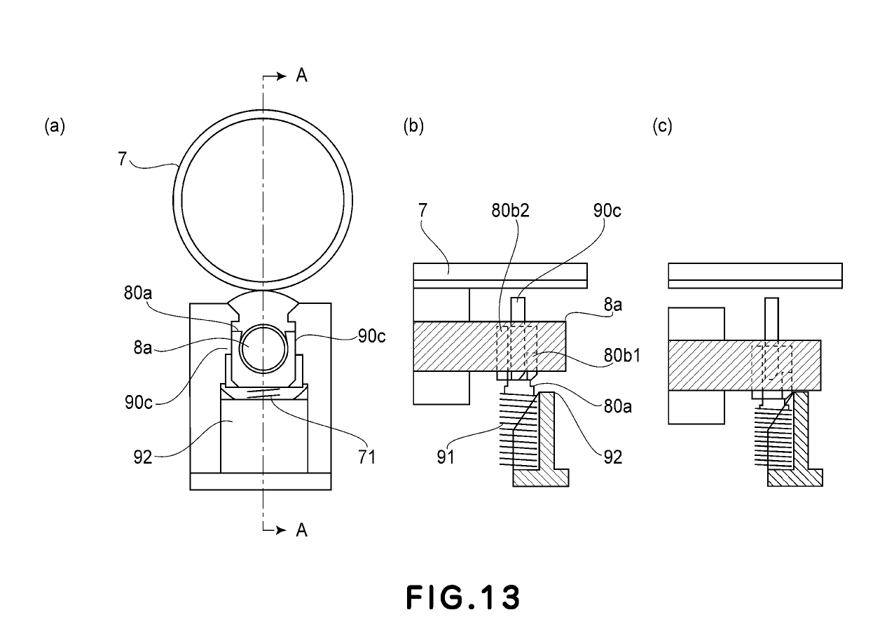

Next, a modified example of Third Embodiment will be described with reference to FIGS. 12 and 13. FIG. 12 is a schematic view for illustrating the supporting structure for the bearing member in the modified example of this embodiment. Parts (a), (b) and (c) of FIG. 13 are a side view and sectional views of the supporting structure for the bearing member in the modified example of this embodiment. Here, (a) of FIG. 13 is the side view of the supporting structure at the first position in which the charging roller 8 is contacted to the photosensitive drum 7, (b) of FIG. 13 is the sectional view of the supporting structure at the first position, and (c) of FIG. 13 is the sectional view of the supporting structure at a position in which the bearing member 80a contacts the guiding portion 91.

As shown in FIG. 2, at the longitudinal outside of the supporting portion 90a of the drum supporting frame 11d, a roller shaft abutting portion 92 which contacts the roller shaft 8a when the bearing member 80a is moved from the first position to the second position is provided. As a result, in the state in which the charging roller 8 is assembled to the bearing member 80a, the bearing member 80a cannot be moved to the second position. For that reason, there is no dismounting of the bearing member 80a from the drum supporting frame 11d. Further, in a state in which the charging roller 8 is dismounted from the bearing member 80a, the bearing member 80a can be easily dismounted from the drum supporting frame 11d by being pushed from the photosensitive drum 7 side toward the second position.

### Fourth Embodiment

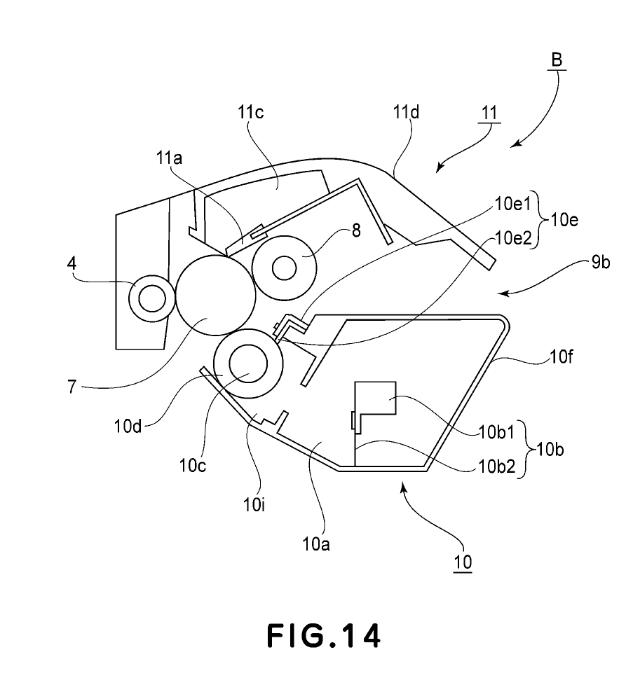

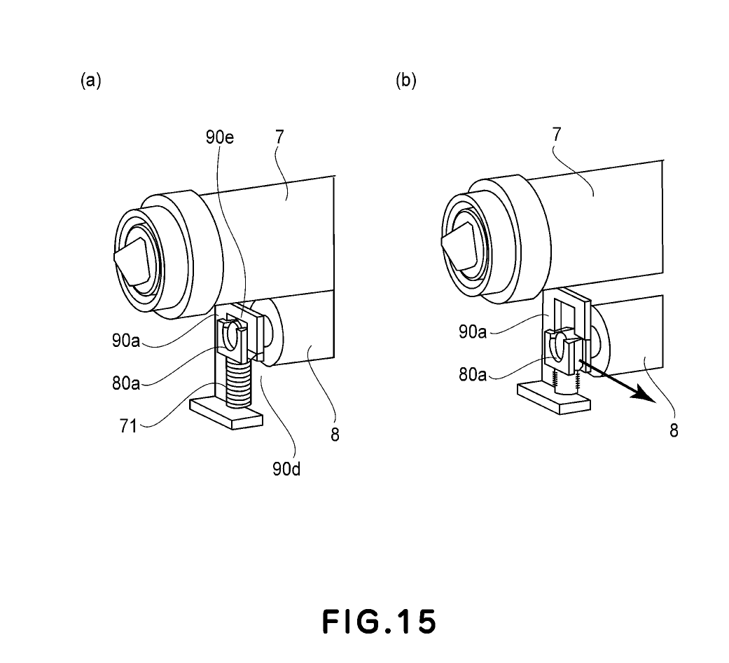

The bearing member supporting structure of the drum supporting frame in this embodiment will be described with reference to FIG. 14. Constituent elements similar to those in First Embodiment are represented by the same reference numerals or symbols. FIG. 14 is a schematic sectional view of the process cartridge in this embodiment.

Here, in FIG. 14, the transfer 4 is integrally disposed in the process cartridge B. Both shaft ends of the transfer roller 4 are rotatably supported by bearing members (not shown). The bearing members are attached to supporting portions (not shown) provided on the drum supporting frame 11d. Further, the transfer roller 4 is attached so as to be slidable with respect to a radial direction of the photosensitive drum 7 by using the supporting portions as rails and is urged toward the photosensitive drum 7 by compression springs (not shown) as urging means.

Here, the process means is the transfer means (transfer member) and the supporting structure of the transfer roller 4 for the drum supporting frame 11d has the same constitution as that in the case of the charging roller 8 described above. As a result, similarly as in the case of the charging roller 8, dismounting of the bearing member from the drum supporting frame 11d becomes easy and thus disassembling easiness is improved.

### Fifth Embodiment

The bearing member supporting structure of the drum supporting frame in this embodiment will be described with reference to FIG. 15. Constituent elements similar to those in First Embodiment are represented by the same reference numerals or symbols. Parts (a) and (b) of FIG. 15 are schematic sectional views of the process cartridge in this embodiment.

The bearing member 80a is supported by the supporting portion 90a and is constituted so as to be slidable and movable between the position (first position) in which the charging roller 8 is contacted to the photosensitive drum 7 and the position (second position) in which the charging roller 8 is separated from the photosensitive drum 7. An end portion 90e of the supporting portion 90a is a suppressing portion for suppressing disconnection, from the supporting portion 90a, of the bearing member 80a urged by the compression spring 71. Here, (a) of FIG. 15 is a perspective view of the process cartridge at the first position in which the charging roller 8 is contacted to the photosensitive drum 7, and (b) of FIG. 15 is a perspective view of the process cartridge at the second position in which the charging roller 8 is separated from the photosensitive drum 7.

According to this constitution, the bearing member 80a cannot be dismounted at the first position but can be dismounted at the second position in an arrow direction (cross-sectional direction perpendicular to the axis of the photosensitive drum 7) in (b) of FIG. 15. Further, the dismounting direction is different from a presence direction of the photosensitive drum 7 and therefore the dismounting of the bearing member 80a becomes possible even in the state in which the photosensitive drum 7 is mounted, so that disassembling easiness is improved.

### Another Embodiment

In First to Third and Fifth Embodiments, the description was made by taking the charging roller, at the process means, as an example. In Fourth Embodiment, the description was made by taking the transfer roller, as the process means, as an example. However, the present invention is not limited thereto. For example, as the process means, a cleaning roller for collecting the transfer residual toner on the photosensitive drum 7 in contact with the photosensitive drum 7 may also be used.

While the invention has been described with reference to the structures disclosed herein, it is not confined to the details set forth and this application is intended to cover such modifications or changes as may come within the purpose of the improvements or the scope of the following claims.

This application claims priority from Japanese Patent Applications Nos. 210497/2010 filed Sep. 21, 2010 and 190350/2011 filed Sep. 1, 2011, which are hereby incorporated by reference.

What is claimed is:

1. A cartridge detachably mountable to a main assembly of an image forming apparatus, comprising:
a process member including a shaft acting on an image bearing member;
a bearing member for supporting said process member;
a frame including a supporting portion for movably supporting said bearing member;
wherein said bearing member is movable, by moving the supporting portion, between a first position in which said process member acts on the image bearing member and a second position which is remoter from the image bearing member than the first position,
an urging member for urging said bearing member from the second position toward the first position;
a suppressing portion for suppressing dismounting of said bearing member, urged by said urging member, from the supporting portion; and
a dismounting portion for permitting dismounting of said bearing member from said frame at the second position.

2. A cartridge according to claim 1, wherein said bearing member includes a preventing portion for preventing said bearing member, at the first position, from moving in an axial direction of said process member, and
wherein the supporting portion has a shape such that said supporting portion sandwiches the preventing portion.

3. A cartridge according to claim 1, wherein said bearing member includes a preventing portion pair for preventing said bearing member, at the first position, from moving in an axial direction of said process member, and
wherein the preventing portion pair has a shape such that the preventing portion pair sandwiches the supporting portion.

4. A cartridge according to claim 1, wherein said dismounting portion is a cut-away portion provided in the supporting portion, and
wherein the supporting portion is provided so as to prevent, at the first position, movement of said bearing member in the axial direction of said process member and so as to dismount, at the second position, said bearing member through the cut-away portion.

5. A cartridge according to claim 1, wherein said dismounting portion is provided so that bearing member is dismountable in the axial direction of said process member, and
wherein said cartridge includes a guiding portion for moving said bearing member in the axial direction of said process member in contact with said bearing member when said bearing member is moved from the first position to the second position.

6. A cartridge according to claim 1, wherein said dismounting portion provided so that said bearing member is dismountable in the axial direction of said process member and in a direction toward a central portion of said process member, and
wherein said bearing member includes a contact portion contacted to an end portion of the shaft.

7. A cartridge according to claim 1, wherein the supporting portion is an arm pair-like shaped portion provided so as to extend in a direction crossing the axial direction of said process member, and
wherein the supporting portion is provided so that said bearing member is insertable into a space in the arm pair-like shaped portion by elastically deforming the supporting portion.

8. A cartridge according to claim 1, wherein said process member is charging means for electrically charging the image bearing member.

9. A cartridge according to claim 1, wherein said process member is a transfer member.

10. A cartridge according to claim 1, wherein said bearing member is formed with an electroconductive member.

11. A cartridge according to claim 1, wherein said cartridge includes the image bearing member.

12. An image forming apparatus comprising:
a main cartridge according to claim 1; and
a main assembly of said image forming apparatus.

13. A disassembling method for disassembling, from a frame, a bearing member provided in a cartridge detachably mountable to a main assembly of an image forming apparatus, wherein the cartridge include:
a process member including a shaft acting on an image bearing member;
a bearing member for supporting the process member;
a frame including a supporting portion for movably supporting the bearing member;
wherein the bearing member is movable, by moving the supporting portion, between a first position in which the process member acts on the image bearing member and a second position which is remote from the image bearing member more than the first position,
an urging member for urging the bearing member from the second position toward the first position;
a suppressing portion for suppressing dismounting of the bearing member, urged by the urging member, from the supporting portion; and
a dismounting portion for permitting dismounting of said bearing member from the frame at the second position, said disassembling method comprising:
a step of moving the bearing member supported by the supporting portion to the second position; and
a step of disassembling the bearing member from the frame.

14. An assembling method for assembling, into a frame, a bearing member provided in a cartridge detachably mountable to a main assembly of an image forming apparatus, wherein the cartridge include:
a process member including a shaft acting on an image bearing member;
a bearing member for supporting the process member;
a frame including a supporting portion for movably supporting the bearing member;
wherein the bearing member is movable, by moving the supporting portion, between a first position in which the process member acts on the image bearing member and a second position which is remote from the image bearing member more than the first position,
an urging member for urging the bearing member from the second position toward the first position;
a suppressing portion for suppressing dismounting of the bearing member, urged by the urging member, from the supporting portion; and
an assembling portion for permitting assembling of said bearing member to the frame at the second position, said disassembling method comprising:
a step of assembling the bearing member into the frame.
